(19) United States
(12) Patent Application Publication
(10) Pub. No.: US 2007/0106553 A1
(43) Pub. Date: May 10, 2007

(54) Pari-mutuel betting with bonus feature

(76) Inventors: Richard Jeffrey Jordan, Las Vegas, NV (US); Michael B. Shelby, Corvallis, OR (US); Michael P. Coppert, Las Vegas, NV (US)

Correspondence Address: MARGER JOHNSON & MCCOLLOM, P.C., 210 SW MORRISON STREET, SUITE 400, PORTLAND, OR, 97204, US

(21) Appl. No.: 10/573,234

(22) PCT Filed: Sep. 15, 2004
(86) PCT No.: PCT/US04/31011

§ 371 Date: Mar. 15, 2006

(51) Int. Cl. G06Q 30/00; A63F 13/00

(52) U.S. Cl. 705/14; 463/20

(57) ABSTRACT

The intention is to provide a variety of bonusing products that function through a bonusing system network intended to recognize and automatically reward players participating in pari-mutuel and wagering in all forms including wagers made at tracks, through tote systems' wagering terminals, Internet, telephone and other electronic means with the ability to track and reward players based on the wagering activity. Contemporaneous with issuance of a betting ticket, or after the results of the race are posted, an award of a bonus can be made in association with the players betting activity. The network also has the capability of connecting electronic gaining machines (EGM). The bonusing network includes functional interfaces to point-of-sale systems (including food & beverage, event ticketing and other retail outlets) and hotel management systems.

### BACKGROUND OF THE INVENTION

1. Field of the Invention

The present invention relates to awarding a bonus on a network of gaming devices, and—more particularly—awarding such a bonus on a wide area network and across various betting activities such as pari-mutuel wagers.

2. Description of the Prior Art

Many casino operating companies own multiple casinos or have associations with wagering events located at various remote sites. It has proved to be advantageous for such companies to devise player loyalty promotions that span these properties. Historically, multi-property player management systems accumulate player activity across all casino properties. For example, many casinos track a player's total wagers, theoretical win, actual win, complementary balance, player point balance, and other key player behavior statistics across all casinos managed by that operator.

This information may be used to determine a global worth of the player to the operator, as opposed to a single playing location. Many casino operators accomplish this by dividing their player database into tiers, with the highest tier being the most valuable players and the lowest tier being the least valuable players from the casino's perspective. The casino typically uses a statistic such as theoretical win to establish player worth. Once this global player worth is established, casinos target promotional offers commensurate a player's worth. The promotions are designed to entice further play at one or more of the operator's casinos.

The promotions usually take advantage of the multi-property nature of the business, such as allowing redemption of promotions at all casinos; targeting redemptions to a single property that might have more capacity that other properties; and using a complementary trip to a more desirable property as a promotional offer

All of these generally rely on manual processes for communication of promotional information to the customers and for redeeming promotions. For example, promotional offers are generally communicated via direct mail to qualifying players, or via brochures, signage and literature at a casino. Further, redemption of promotional offers—whether they are cash, complementaries (“comps”), etc.—is generally done manually at a players-club booth at each casino.

As used herein, the term bonus is an award, e.g., like the promotional offer, given to a player of an electronic gaming machine (EGM). The term bonus herein refers to any such award that is not paid by the device in accordance with its pay table. Such bonuses and systems for implementing them are described in U.S. Pat. No. 5,655,961 (the '961 patent) and in co-owned U.S. Pat. No. 6,319,125 (the '125 patent), both of which are hereby incorporated herein by reference for all purposes. Also hereby incorporated by reference for all purposes is U.S. Pat. No. 6,375,569, which describes a bonus promotion like the one described herein, except implemented at a single casino. A bonus can include an award of cash or machine credits, player points, or complementary amenities.

In a first implementation of the present invention, as participating EGMs are played, a user-selected percentage of the play is added to a common bonus pool. When the pool reaches a randomly selected level of play, between specified minimum and maximum numbers, a winner is randomly selected. The award can be a fixed cash amount, a cash amount linked to the bonus pool total or a non-cash prize. Prizes, such as consolation or celebration prizes that are typically smaller than the winning bonus, can also be awarded to non-winning players.

In the preferred embodiment, a master server, located at one of a plurality of participating casinos, communicates over a wide area network with slave servers located at each participating casino. The preferred embodiment may support a master server, up to 32 slave servers, and may accommodate as many as 16 different bonus pools that operate to pay a bonus award to one of the EGMs associated with the respective pools. It should be appreciated that other embodiments could support more or less slave servers and bonus pools. For each bonus pool, the master server selects a winning slave server, which in turn selects a winning EGM.

The preferred embodiment is called the Random Rewards® promotion. The promotion is complete when the amount of play on participating EGMs reaches the randomly selected number between the minimum and maximum numbers, which are specified at the master server. The randomly selected number is called the lucky number. Preferably a player must be issued a player-tracking card to be eligible to participate. Although the invention is not so limited, a typical implementation is for a plurality of casinos that are commonly owned with each recognizing a player-tracking card issued by any of the others. As a result, player activity is tracked—in a known manner—across all of the casinos.

While these linked progressive systems have been effective at drawing additional players, there is a need for gaming machines that have additional attraction features and yet are not required to be linked to other machines. Furthermore, it would be desirous to track and reward player loyalty beyond the casino environment. Accordingly, what is desired is a systems that monitors, implements, and tracks loyalty reward programs across desperate operating systems running various gaming activities such as horse racing at a track, off-track better, video lottery terminal (VLT), Internet horse race betting, and slot machines.

### SUMMARY OF THE INVENTION

As implemented in the present invention, the customer's worth is tracked across all gaming activities including horse betting, video lottery terminal (VLT), and slot wagers. FIG. 1 shows a simplified wide area betting network. The anticipated hardware system is nearly identical to FIG. 1 with the exception that some “casinos” 16 are actually betting tracks with betting kiosks instead of slot machines 28, 30. The rest is the same including router 20, concentrator 24, slave server 26, and display 35. The master server 14, in the pari-mutuel setting, includes a program called the external data interface (XDI) and is coupled to a patron management database.

The intention is to provide a variety of bonusing products that function through a bonusing system network intended to recognize and automatically reward players participating in pari-mutuel and wagering in all forms including wagers made at tracks, through tote systems' wagering terminals, Internet, telephone and other electronic means with the ability to track and reward players based on the wagering activity. The operation of standard tote systems, such as the Totalisator Systems sold by Autotote Systems, Inc. are well known in the art and thus not described further here. The network also has the capability of connecting electronic gaming machines (EGMs). The bonusing network includes functional interfaces to point-of-sale systems (including food & beverage, event ticketing and other retail outlets) and hotel management systems.

Player identification on the network at any gaming outlet, device or point of purchase takes place through an individual account number and PIN. Identification could be automated through the use of a magnetic striped card encoded with the player specific information. Identification could also occur through a web or phone interface with the player manually entering his individual account number and PIN. Once identified and acknowledges as active by the system, the player's spending will be tracked within the system. The system has the ability to send player specific messages and awards based on a variety of variables relative to the player's spending behavior.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a schematic diagram of a multi-property bonus system implemented in accordance with the present invention.

FIG. 2 is a schematic diagram of a more specific embodiment of the multi-property bonus system of FIG. 1 with pari-mutuel betting.

FIG. 3 is a diagram showing a gaming device including a game ticket printer and a system ticket printer, according to a further embodiment of the invention.

FIG. 4 is a block diagram showing a network of gaming devices including a promotion function according to embodiments of the invention.

FIG. 5 is a functional block diagram showing processes and functions used in the wagering network of FIGS. 1 and 2.

FIG. 6 is a functional block diagram showing processes and functions used in the gaming device of FIG. 3.

FIG. 7 is an example flow diagram showing processes that can be performed by the ticket printer function of FIGS. 4-6.

FIGS. 8-13 are examples of tickets that can be issued by embodiments of the invention.

### DETAILED DESCRIPTION

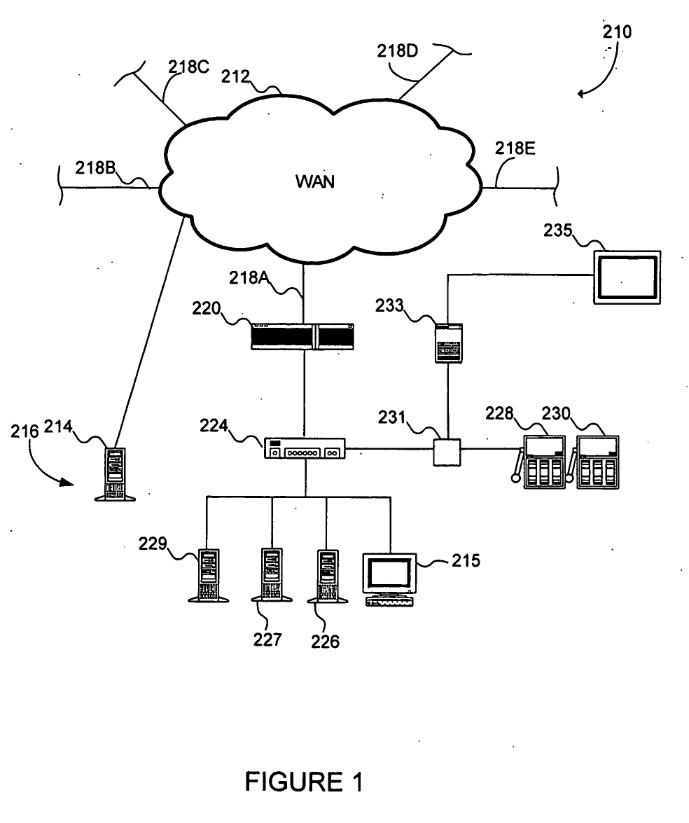

Operation of the network is similar in nature to that described in U.S. patent application Ser. No. 10/256,949 which is incorporated herein for all purposes and shown in FIG. 1. Briefly, FIG. 1 shows generally at 210 is a system constructed in accordance with the present invention. It includes a wide-area network (WAN) 212 that incorporates a single master server 214. Also included in the WAN is a configuration workstation 215, including a keyboard, monitor, and software, that permits a user of the workstation to configure the master server. Portions of WAN 212 are located at different casinos, one of which is depicted generally at 216. Each casino includes a local area network (LAN), like LAN 218a at casino 216. LAN 18a includes a router 220; a concentrator 224; a slave server 226, which—among other things—tracks carded electronic gaming machine (EGM) play in a known manner; a player server 227, which provides messages to displays associated with the EGMs; a key distribution center 229 (KDC), which implements security as will be described; and a plurality of EGMs, only two of which are exemplary slot machines 228, 230. In addition, a bank controller 231 facilitates communication between slot machines 228, 230 and concentrator 224. Bank controller 231 provides the same function for an animation computer 233, which generates animated content that appears on a display 235.

The same components (except for a master server, like master server 214) appear in LANs 218a, 218b, 218c, 218d (not shown) at each of the other casinos (also not shown) on the WAN. It should be appreciated that the master server may also be located at a site remote from any of the participating casinos, or—as in the present embodiment—at one of the casinos; specifically, master server 214 is located at casino 216. Although specified network structure is depicted, the invention can be implemented on any suitable network, regardless of its design or the hardware with which it is implemented.

Router 220 transmits data packets between the master server and each slave server over WAN 212. Depending on topography of the network, a hub could be used in lieu of router 220. Concentrator 224 is a network device similar to a hub that provides communication routing for devices on the network.

As described in the '961 patent, each EGM at each casino includes a communication board. This board, among other things, receives bonus promotion and message information from bonus servers and sends EGM meter information, among other things, to network computers, including the slave server, like slave server 226.

Consideration will now be given to configuration of master server 214, which must be undertaken before play can begin. Master server 214 is configured at workstation 215 with a user-specified contribution rate (e.g. 20% of credits played) that EGMs contribute to the growth of a bonus pool, which is called the current pool. In general terms, as play progresses on participating EGMs, the current pool is incremented by the contribution rate multiplied by the total play on the EGMs. When the current pool reaches or exceeds the lucky number, the master server randomly selects a winning slave server. The winning slave server then randomly selects the winning EGM. EGMs that require different denominations to play can be incorporated into the same pool using known techniques to account for the difference in denominations from game-to-game within the pool.

In the multi-casino Random Rewards® promotion, selecting minimum and maximum numbers at master server 214 specifies the range from which the winning number is selected. The range corresponds to a level of play by the participating EGMs; the total current pool results from all plays made on all EGMs participating in the multi-casino promotion. Master server 214 is also configured with a list of all slave servers participating in the promotion. The current pool represents the combined contributions of each slave server. Each slave server pool total further represents the combined contribution of all EGMs participating in the promotion at the associated slave server's casino.

Each slayer server is also configured, primarily by designating which EGMs are linked to a particular bonus pool. The slave servers are also configured using their associated workstation, like server 226 is configured by workstation 215. Each local configuration workstation can be used to configure the master server and the associated local server, but a workstation at one location cannot be used to configure a slave server at another location.

The major elements of the system can be implemented as follows:
(1) Patron management system for entering patron data including an “Admission System.”
(2) Master Server with external data interface (XDI).
(3) MEC Central site.
(4) Betting locations including
   a. Point of sale (POS) systems/kiosks—need operational details of these;
   b. Off-track betting sites—Internet capable computers in people's homes/Casinos; and
   c. On-track betting kiosks and windows.

The second aspect of the invention is the promotional scheme used. Several are identified below, such as: (1) scheduled return play, (2) free wagers, (3) lottery-type drawings, etc. Eligibility of the player is typically a factor in the award, e.g. whether they played that day, have bet beyond a certain amount over a period of time, or whatever. Player notification can be by issuing the $/coupon/ticket the next time the player visits the betting kiosk after an award.

The invention contemplates a system that integrates multiple desperate operating systems to create a program that monitors, implements, and tracks loyalty reward programs. The desperate operating systems run various unique gambling activities, i.e. horse racing at a track, off-track betting (OTB), gaming at a video lottery terminal (VLT), Internet Horse Race betting, and slot machines. The system allows for real-time data collection and updating of operating systems in various locations spread over a wide geographic region. The real-time nature of the system allows for any of the individual operating entities to know who the customer is and the worth to the corporation as they enter a facility, place a wager or purchase a good. The system also allows the corporation to award bonuses or coupons or other promotional goods to consumers based upon their total worthwhile they are at any number of facilities. These bonuses can be redeemed at the same facility or at another facility under the corporate banner.

The advantages of this system over other system is the ability to track gaming activity over a diverse ranges of gaming entities, while offering the customer rewards for that activity. Additionally, the system can calculate the customers worth based on all gaming activities, including horse betting, VLT and slot wagers.

System Overview

The preferred embodiment of the system is built on the Microsoft® Windows™ platform although those knowledgeable in the art would appreciate that other technologies for communication and data integrity into the present architecture.

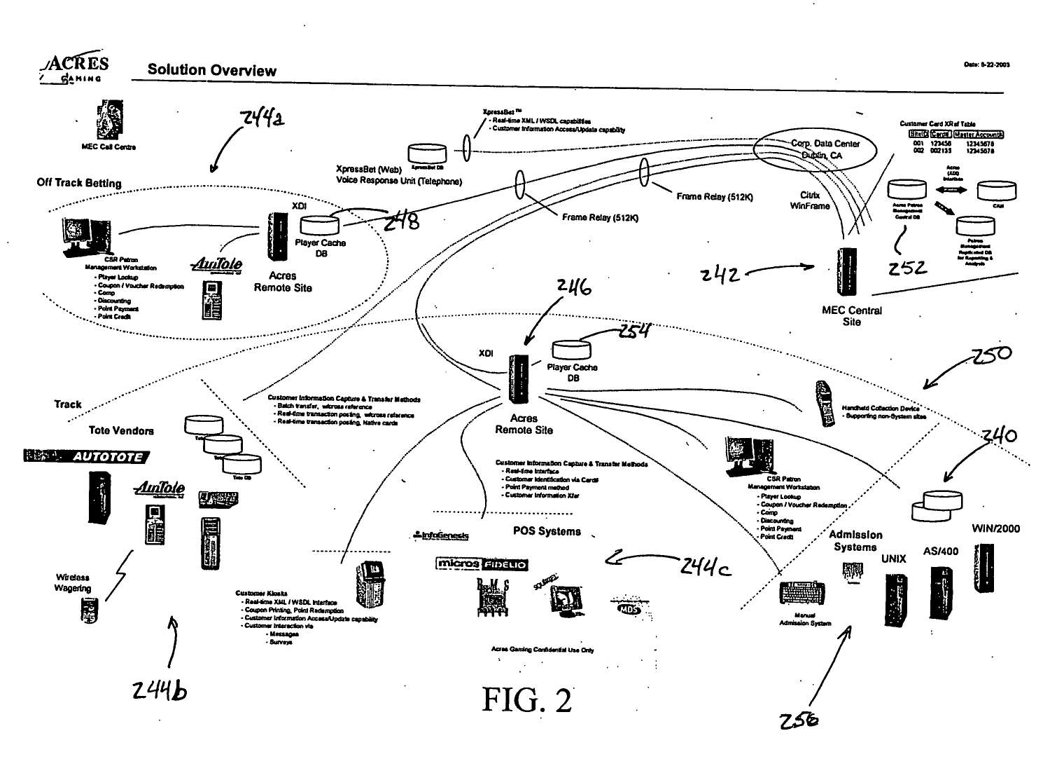

The logical architecture, as shown in FIG. 2, revolves around a central Patron Management (PM) database 240. This database 240 stores all player information including such items as player activity, points, and point redemptions. The central PM database 240 allows complete, timely and accurate player information retrieval. It also contains protective mechanisms covering customer point data and the process over which point redemptions take place. In this consolidated system reside all of the auditing and accounting functions necessary to support intra-company accounting and expense charge backs with respect to point liabilities and point redemptions across many locations.

Administration and configuration of the PM system can be accomplished at both the MEC central data center 242 and by the individual locations 244a, 244b, and 244c according to permissions granted to each entity.

Coupled with the centralized command of the PM database 240 is a powerful software module that handles interfaces to the PM database. The module, named eXternal Data Interface (XDI) 246, is intended to provide serviceability, maintainability, robustness, and redundancy as will be explained further below. XDI comprises a robust multi-threaded program capable of facilitating multiple interfaces. XDI is adapted to handle XML, Message Queues, TCP/IP, UDP, and serial or any other standardized communication protocol. XDI can interface through web communication using Microsoft's Internet Information Services (IIS) server in a clustered environment.

When electronic gaming terminals (EGTs) are installed in a Track or OTB location, a local Player Cache database 248 is installed. As its name suggests, the local Player Cache 248 is a backup and temporary storage point for the EGT ratings data that are forwarded in real-time to the PM database. In the event communication lines to the PM central site 250 are severed, the Player Cache queues transactions and continues to service EGT players. When communication is restored, transactions are forwarded from the Player Cache to the PM database.

Applicant's BIF module is used to place the EGT ratings into the PM database 240. The BIF module also supports proprietary interfaces to the POS systems such as InfoGenesis and Micros.

Core-Functionality

Listed below are key components for implementing MEC required Core Functionality.
a) Applicant's Patron Management Database (MEC Central Site)
b) Applicant's' Player Cache Database 252 (on site at Track and OTB locations with EGTs)
c) Applicant's' XDI Interface 246 to Tote System 244b (on-site at Track and OTB locations)
d) Applicant's' Player Cache and BIF Module (for EGT interface and Micros/InfoGensis interfaces) 254.
   Additional Functionality
a) XDI interface to point-of-sale (POS) System—on site at Track POS outlets for MDS, Squirrel, and RMS systems.
b) XDI interface to Admission System (on site at Tracks)
   Technical Architecture

Acres Advantage is built on the Microsoft technology platform. All databases are implemented in the Microsoft SQL Server 2000 product. The operating software components comprising applicant's system run on the Windows 2000 network. The standard Acres Patron Management application is programmed with Microsoft Visual C++. This allows Object Linking and Embedding (OLE) automation and integration with Microsoft Office and other products. In particular, screens in all of applicant's user applications can be exported to Excel with a single mouse click. Applicant provides a web portal though which a customer may enroll or change their account, view promotional information, submit contact requests and view point balances. The web portal is implemented by way of an ASP page that is secured by firewall. Prepackaged System Reports are handled through Seagate Crystal. The system features a Cognos catalog for enabling data queries and report writing.

Other technical areas of the Acres Advantage System include:

Database Architecture

The Acres Advantage solution is built on Windows 2000 SQL Database Structures. Our design implements sever-side stored procedures, providing a performance boost for complex queries. This implementation has proven to easily handle over 1.2 million transactions per day at our busiest installations. Backend server utilizations operate at 30% to 40% utilization under these loads.

System Architecture

The system is built primarily with Microsoft components. It has been carefully designed around a 3-tier architecture. The system takes full advantage of the server-side stored procedures with careful consideration of indexing over critical structures.

Primary benefits of this design include the following:
Precompiled execution. SQL Server compiles each stored procedure once and then reutilizes the execution plan. This results in tremendous performance boosts when stored procedures are called repeatedly.
Reduced client/server traffic. In this design, calculations, selections, projects, temporary tables etc. are all handled on the server, thus reducing long SQL queries to a single line that is transmitted over the wire.
Efficient reuse of code and programming abstraction. Stored procedures are shared by multiple users and client programs, thus improving overall performance and reducing memory resource usage.
   Client Communication Architecture

Applicant takes full advantage of Microsoft's Com+component technology supporting a number of key areas of the system.
Workstation-level component technology
Distributed applications via remote component instantiation and method invocations

In addition to the coherent, enterprise-worthy component technology, this implementation also eliminates ODBC license costs necessary in implementation.

This technology supports both fat and thin clients. Large scale implementations, consisting of high quantities of distributed workstations have benefited from the introduction of the CITRIX® WinFrame/MetaFrame® solutions. Applicant fully supports this environment.

Tote Interface

There are two options in the Tote interface. The first assumes that the Tote system cannot forward data in real-time, leading to a batch interface. In this case, the Tote File containing the ratings would be accessed on a batch basis on a pre-configured schedule. The customer points and ranking would be calculated as the batch file is being processed. In batch processing, Applicant' invention employs an error detection and correction scheme that allows for the presentation and correction of data transactions that cannot be matched to a specific account.

The second alternative assumes that the Tote System can forward ratings in real-time at the time of customer wager. The Tote System may have its own player card or may use the Player Rewards System card; the Inventive system will resolve either card by cross-reference look up. Points awarding can either be handled by the Tote System (in which case the points are forwarded to the Inventive system and added to the balance), or the points can be calculated by applicant's PM system. Applicant's system could forward the calculated points back to the Tote system for terminal display or receipt printing. The points they are immediately visible at the CSR Acres Patron Management application.

Service Availability

High availability of the system is important and Applicant utilizes technology to reduce hardware and software failures. Applicants' databases are intended to be clustered for server fail over. RAID 1 or 5 schemes for hard drive data redundancy features allow for the protection of valuable data. The XDI module is designed around Microsoft's IIS server for it Web Interfaces. IIS can run inside a cluster. Another aspect of XDI moves data through various interface methods (XML, message Queues, etc.) and is programmed a service. Should the XDI service fail, it will restart.

Optimizing Performance

Optimization and performance time minimization are important aspects of coding a system of the scale as that required by MEC. Applicant's experience in multi-site high transaction volume Player Management systems has led to several initiatives which demonstrate performance and optimization. Additionally, Applicant's products are designed the face the challenge of geographic distance across North America. For example, the Acres Patron Management System installed at MGMMIRAGE has a centralized database in Las Vegas that links casinos in Las Vegas, Detroit, and Mississippi.

With respect to the Wide Area Network (WAN), Applicant implements the following:
Working closely with network technicians to ensure network is correctly implemented.
Ensuring the bandwidth is sufficient for the volume of data throughput required.

When it comes to programming data transfer routines Applicant uses the following guidelines:
Break work load down into multiple data streams for forwarding and acknowledging data.
Develop the software as multiple threads leads to effective use of the bandwidth of the network.
Write software that helps optimize TCP/IP packet size to minimize Ethernet repacketizing.
Guaranteed data delivery in the algorithms that send and process data.

With respect to data storage and query facilities, Applicant knows that efficient data table structures and queries are very important to services the operation needs. Applicant takes the following steps to optimize it database software.
Efficient table, view and index design.
The application is tested in Applicant's lab under simulator load conditions that approximate the operation's transaction volumes and database sizes (using simulator tools developed by Applicant).
Query analyzer is used to optimize query plans.
Applicant distributes the load wherever possible, for example, Message Queue server typically resides on a separate server.

Applicant makes efficient use of the database resources and connections:
COM+database connection management optimizes connections to database and pools connections at lowered licensing costs.

Connected Systems:
Tote Systems 44b
Admission 56
Custom Internet Wagering Database
Customer Care Applications
EGMS—Slots or VLT's

Customer Touch Points
Tote Machines—Standard tote machines that come with system. These machines are used to track horse racing wagers. They can include as an interface the ability to recognize the customer at the device or they can recognize the customer utilizing a display, vacuum fluorescent display (VFD) or Nexgen display to communicate with the customer.
Admission—Electronic counters count the number of people entering the facility. Admission systems track individuals via a card. This system could have a display like NexGen, which would allow the operator to recognize players deserving free or reduced admission. Also, could allow the customer to pay for admission with points.
EGM's—These electronic gaming machines are well known in the art.
POS—ability to purchase goods with points via a point of sale system at a variety of outlets at an individual location or spread over a geographic region.
   Information Tracked

Horse Racing—The wager, amount of the wager, race wager on, type of wager, runner (horse), result etc.

There are three types of basic wagers in a pari-mutuel horse racing event. A WIN wager pays off only if the horse comes in first. A PLACE wager pays off if the horse bet on comes in first or second. In a SHOW wager, the bet pays if the horse comes in either first, second, or third.

The table below shows an example of a paytable for each of the bets explained above when the finish order of a horse race is the horse “Sezyou” in first place, the horse “Lucky Touch” finishing in second, and the horse “Belle Borne” finishing in third place. The payoffs for a two dollar bet would be as follows:

TABLE 1
Wager Payouts on $2 Bet

| HORSE | WIN | PLACE | SHOW |
|---|---|---|---|
| Sezyou | $10.80 | $6.20 | $3.20 |
| Lucky Touch | No pay | $5.20 | $3.00 |
| Belle Borne | No pay | No pay | $2.20 |

If you bet $2 to win and place on Sezyou, you collect $10.80 for the win and $6.20 for the place. Your total wager is $4 and you collect $17. If you bet $2 to place on Lucky Touch, you receive $5.20. If you bet Belle Borne to show, you receive $2.20. A bet on any other horse would not result in a win according to the table above.

The odds on the tote board reflect a horse's price to win. To calculate the winning payoff for a $2 bet, multiply the odds by two and add $2 (the original wager). For example, if a horse goes off at 3-1, he will pay $8. [(3×$2)+$2]. Other payoffs are shown in the table below:

TABLE 2
Payoff by Odds

| ODDS | $2 Bet Returns |
|---|---|
| 1-10 | $2.20 |
| 1-5 | $2.40 |
| 2-5 | $2.80 |
| 1-2 | $3.00 |
| 3-5 | $3.20 |
| 4-5 | $3.60 |
| 1-1 | $4.00 |
| 6-5 | $4.40 |
| 7-5 | $4.80 |
| 3-2 | $5.00 |
| 8-5 | $5.20 |
| 9-5 | $5.80 |
| 2-1 | $6.00 |
| 5-2 | $7.00 |
| 3-1 | $8.00 |
| 7-2 | $9.00 |
| 4-1 | $10.00 |
| 9-2 | $11.00 |
| 5-1 | $12.00 |
| 6-1 | $14.00 |
| 7-1 | $16.00 |
| 8-1 | $18.00 |
| 9-1 | $20.00 |
| 10-1 | $22.00 |
| 12-1 | $26.00 |
| 15-1 | $32.00 |
| 20-1 | $42.00 |
| 40-1 | $82.00 |
| 80-1 | $162.00 |
| 100-1 | $202.00 |

Other examples of types of race betting include daily double, exacta, quinella, trifecta, pick three, and pick six.

Traditionally, the daily double was the first two races on the card, but now there may be several daily doubles or doubles on a card. You have to select the winner in each of the two designated races. For example, most tracks have an early daily double on races one and two. You must pick the winner of race one and the winner of race two. If you like the 8 horse in the first and the 3 in the second race, you would say to the teller: $2 Daily Double 8-3. If the 8 wins the first race and the 3 the second race, you win!

For an exacta bet, the two runners you select must come in the exact order. For example, if you select horse 3 to run first and horse 1 to finish second, they must finish in that order. You would give the bet as follows: $2 exacta 3-1.

For quinella, the two horses selected may come in either first or second. For example, if you bet a 3-8 quinella, you win if the finish is 3-8 or 8-3. Make the wager by saying: $2 quinella 3-8.

For trifecta bets, runners you select must finish one, two, three in the exact order. Make the wager by saying. $2 trifecta 6-8-10.

For the pick three bet, the player must select the winners of the three designated races. For example, if there is a Pick 3 on races 4, 5, 6, you must pick the winners of all three races. A pick 6 is similar, except that the player must pick the winners of six consecutive races

Wagering strategies are another aspect of pari-mutuel betting. Using the “box” strategy, boxing runners gives one more opportunities to cash a bet. For example, if the player believes that both the 3 and 5 have a shot at winning the race, but elects to just play a straight 3-5. If it comes in 5-3, the player will be upset that he or she did not box the two runners (that is, play a 3-5 and 5-3). Be aware, however, that a box costs more than a straight bet.

Using an exacta box, the player makes multiple bets to play all permutations of the horses the player wants to bet on. To bet an exacta box, tell the clerk: $2 exacta box 3-5. Since this is two wagers (player wins if it's 3-5 or 5-3) the ticket will cost $4. If the player wants to box three numbers, it will cost $12. With more runners, you have more chances to win but it is correspondingly expensive. For example, if the player plays a 1,3,5 exacta box, the player wins if the first two runners are 1-3, 3-1, 1-5, 5-1, 3-5, 5-3. A twelve horse exacta box would cost 132 $2 bets, or $264.

A trifecta box works similarly to an exacta box, except the horses are bet to finish win, place, show. Thus, a three horse bet is a minimum trifecta bet. A 3 horse trifecta box bet would cost $12; a 4 horse box $48; a 5 horse box $120, etc. A 12 horse trifecta box bet would cost $2,640.

The box is a great wager when you want to put more than one horse on top, but if you absolutely, positively love a horse to win a race, then you might want to key him. Let's say you like the 3 runner to win. To use him on top of three horses in an exacta, you would say $2 exacta key 3 with 5, 7, and 8. The total bet would be $12 (three bets: 3-5, 3-7, 3-8).

Slots and VLT—Standard Ratings:

Points
Points can be accumulated by a specific corporate calculation or can be specific to the particular business entity.
   Self Service Kiosk:
Kiosk print coupons
View account information, make updates.
Require or not require a pin
Receive cash back
Access ATM, Cash Advance or credit functions
Access surveys or answer survey questions.

The intention is to provide a variety of bonusing products that function through a bonusing system network intended to recognize and automatically reward players participating in pari-mutuel and wagering in all forms including wagers made at tracks, through tote systems' wagering terminals, Internet, telephone and other electronic means with the ability to track and reward players based on the wagering activity. The network also has the capability of connecting EGMs. The bonusing network includes functional interfaces to point-of-sale systems (including food & beverage, event ticketing and other retail outlets) and hotel management systems.

Player identification on the network at any gaming outlet, device or point of purchase takes place through an individual account number and PIN. Identification could be automated through the use of a magnetic striped card encoded with the player specific information. Identification could also occur through a web or phone interface with the player manually entering his individual account number and PIN. Once identified and acknowledges as active by the system, the player's spending will be tracked within the system. The system has the ability to send player specific messages and awards based on a variety of variables relative to the player's spending behavior.

Examples of Bonuses

1. Free Race Wager for pari-mutuel wagering. A player receives a free pari-mutuel wager offer with a specific monetary value if he places previous wagers within a specified time frame that meets a preset value criteria established by the operator. Other player behavior could also be used as the trigger. For example a player wagering $100 in total in one day would be rewarded with an additional “free” wager with a $5 wager. This wager would have no cash value in and of itself, other than through use specified by the network operator. The reward would allow the player to make an additional wager that would be accepted only at specified pari-mutuel wagering locations.
2. Free Multi-Use Wager for pari-mutuel wagering. A player receives a multi-use gaming wager offer with a specific amount if he places previous wagers within a specified time frame that meet a preset value criteria established by the operator. In this instance, the reward can be used for pari-mutuel wagering or at the establishment's slot machines or to purchase/participate in other gaming activity that may be available (i.e. pull tabs etc.)
3. Delayed Free Race or Multi Use Wager for pari-mutuel wagering. A player receives either of the two offers outlined above in 1 & 2; however, it cannot be redeemed until a specific point in the future as determined by the operator. This type of promotion is commonly known throughout retail as a “bounce back”.
4. Electronic Drawings for pari-mutuel wagering. A player automatically receives a virtual drawing ticket after he meets pre-set spending or gaming criteria as established by the casino operator. Drawing tickets for all players participating in the promotion “reside” and are tracked by the system. At a time predetermined by the casino operator, the system will randomly select on electronic ticket from the pool of available tickets in order to determine a winner. The operator may use an interface to a ticket printer to create a hard copy of the ticket. The ticket can be printed and given directly to a player to place in a central drawing location, or the ticket printer can be configured in a manner that automatically places the printed ticket into a ticket receptacle at a central drawing location as it is earned.
5. Multi-property capability for awarding Bonusing to pari-mutuel wagering. The architecture of the technology is designed to allow an unlimited number of participating gaming or wagering outlets within the same enterprise to participate in the same incentive or promotions. Therefore, a player could conceivably earn a reward at a specific facility or through electronic means and redeem the reward at a different facility in a different location within the enterprise.
6. Pool Based pari-mutuel Bonuses. (Lucky Coin & Lucky Time) A percentage of each pari-mutuel wager made by a defined group of players can be expensed to a bonus pool. The bonus pool can be configured to hit before it reaches a predetermined monetary amount. Alternatively the bonus pool can be configured to hit before a predetermined time parameter. At some point in time, either determined arbitrarily during the accrual of the bonus pool, or with the time parameter, the system determines that it is going to select a winner. The bonus pool is awarded to a player who is currently active—placed a wager during that day's set of races. The winner is selected by the system randomly selecting one player from the group of active players. The eligible group can be configured to be just those players who are physically at the racetrack making wagers, or it can include all betters from all sources including Off Track Betting and other electronic means. Only players who are eligible to receive the bonus pool can have a percent of their wager utilized to fund the bonus pool.
7. Abstract Concept for pari-mutuel Bonuses. There are numerous variables that could impact who, what, where, when and why a Bonus is received. This section identifies some of those variables.
   Eligibility:

The Bonusing system has the capability of determining which individual players or groups of players may be eligible for a specific reward.
Eligibility can be determined by being tracked. For example, only tracked players are eligible for a specific Bonus.
Eligibility can be determined based on a specific time frame, either individually or for a group. For example, only on an individual player's birthday or anniversary or anniversary. Or, in the case of a group, only on Jul. 4, 2003.
Eligibility could be based on Recency; for example, only players who made a wager within a predetermined time period.
Eligibility could be based on Frequency; for example, only players with a predetermined number of visits within a specific time frame.
Eligibility may be determined based on monetary value of an individual or group of wagers, the type of wager i.e. Daily Double, Exacta, Quinella, Trifecta, Pick Three or other exotic wager.
Eligibility could also be determined based on a player's ability to correctly wager on a number of race outcomes, for example, a Bonus could be paid after a player selects a predetermined number of Wins, Place, Shows or specified exotic wagers within a prescribed time period.
Eligibility can be based by combining several variables, for example; those players who wager a minimum of monetary amount, on a specific type of wagering, within a specific time frame.
Eligibility could also be determined based on specific player demographics, historical behavior and other variables.
   Bonus Triggers for Pari-mutuel Wagering:

In much the same way as controlling eligibility, the Bonusing system can determine exactly what will trigger a specific reward. Examples include consecutive race outcomes, consecutive race outcomes within a prescribed time frame, purchasing behavior; for example, where the player spends a predetermined amount within a prescribed time frame or on a specific wager type, visit frequency, and random triggers-such as those described in the pool based and time based section (#6) above.

Bonus Funding for Pari-mutuel Wagering:

Funding of the bonus award can be pool based (described in #6), a fixed monetary value, a fixed complimentary food, beverage or retail value, rebate % of wagers, and a rebate of % of wagers within specific time frame.

Payment Mechanisms:

Finally, bonuses can be paid via a non-cashable pari-mutuel wagering credit, a non-cashable slot wagering credit (XtraCredit described in applicants U.S. Pat. No. 6,244,958), cash, cash voucher, comp voucher, drawing tickets, merchandise, as a multiple of the last bet, and a non-monetary awarde—e.g. fixed prize; car, concert tickets etc.

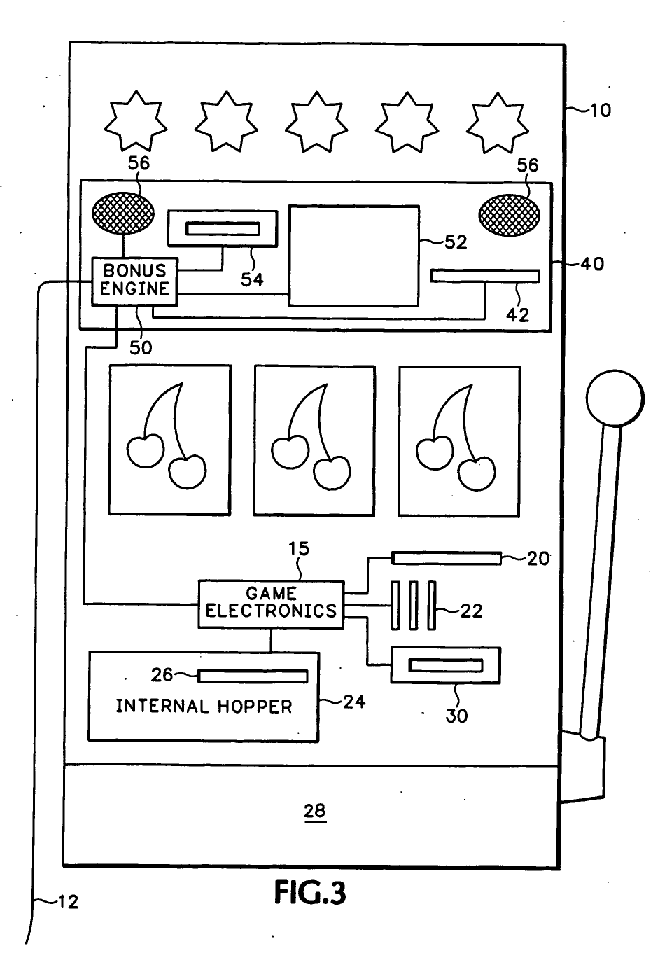

FIG. 3 shows a gaming device 10 shown in slot machine form, although it is understood that betting kiosks such as Tote systems can be similarly configured. This variation includes a system printer 54 and speakers 56 mounted to the frame 40 of the player tracking system. The system printer 54 and speakers 56 are also coupled to and managed by the bonus engine 50. The system printer 54 works in conjunction with the game printer 30 in that the system printer 54 prints the awards while the game printer 30 prints the traditional game cashout vouchers. The speakers 56 can be made to produce sounds or music by the bonus engine 50.

Although the specific hardware included in the gaming device 10 is important in implementing embodiments of the invention, the invention can operate regardless of the type of components in the gaming device 10.

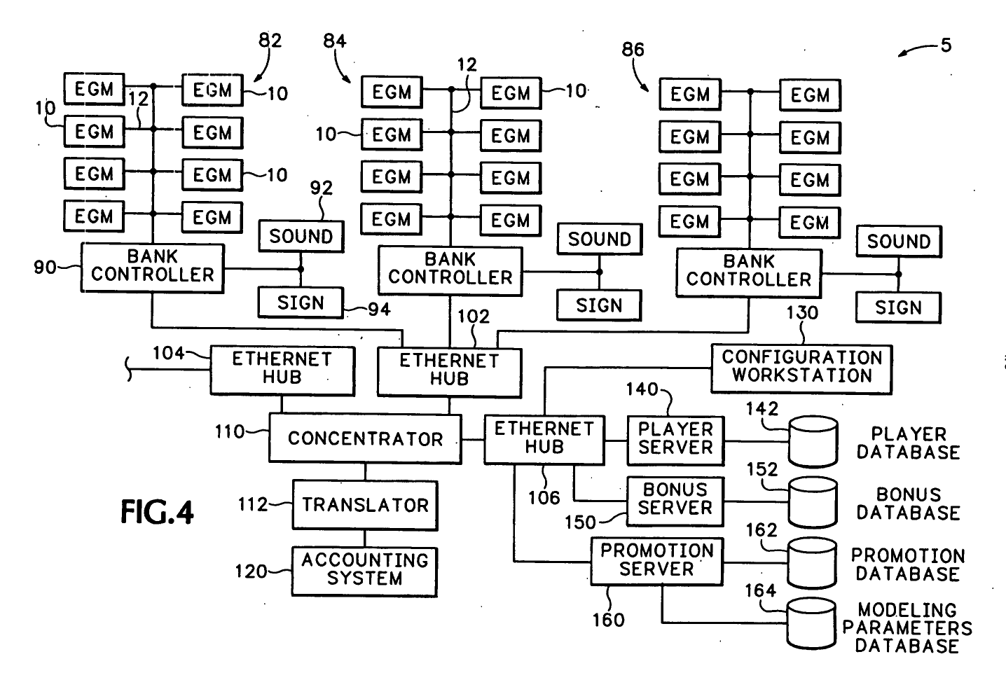

As mentioned above, the gaming device 10 shown in FIG. 3 operates in conjunction with a gaming network. An example modern gaming network 5 is shown in FIG. 4. FIG. 4 is similar to FIG. 1 of U.S. Pat. No. 6,245,483B1, assigned to the assignee of the present invention, the teachings of which are incorporated herein in their entirety for all purposes. In FIG. 4, several gaming devices 10 (Electronic Gaming Machines, or EGMs) are coupled together in groups called banks. The three banks illustrated in FIG. 4 are referenced as 82, 84, and 86, although any number of banks could be present in the gaming network 5.

Each of the gaming devices 10 in each bank are coupled to a bank controller 90 by the communication cable 12. Each bank controller 90 includes a processor that facilitates data communication between the gaming devices 10 in its associated bank and the other components on the network. The bank controller 90 can also include audio capabilities, like a CD or DVD ROM drive coupled to an audio board or sound card for transmitting digitized sound effects, such as music and the like, to a sound system 92 coupled to the bank controller. The bank controller 90 can also be connected to an electronic sign or screen 94 that displays information, such as scrolling, flashing, or other types of messages that indicate jackpot amounts and the like, which are visible to players of machines on a particular bank. These message displays 94 are generated and changed responsive to commands issued over the network 5 to the bank controller 90. Each of the other banks 84 and 86 include associated bank controllers, sound systems, and signs as shown, which operate in substantially the same manner. The sounds and images created by the bank controller may be identical for each of the banks 82, 84, 86, or all of sounds and images created by the banks may be different than the others.

A network connector, such as an Ethernet hub 102 connects each of the bank controllers 90 to a concentrator 110. Another Ethernet hub 104 connects similar bank controllers (not shown), each associated with an additional bank of gaming devices 10 (also not shown), to the concentrator 110. The concentrator 110 functions as a data control switch to route data from each of the banks to a translator 112. The translator 112 includes a compatibility buffer between the concentrator 110 and a proprietary accounting system 120. The translator 112 functions to place all the data gathered from each of the bank controllers 90 into a format compatible with the accounting system 120. The translator 112 could be implemented by a microcomputer including a microprocessor and operating system, such as an Intel Pentium microprocessor running Microsoft Windows NT 4.0.

Another Ethernet hub 106 is connected to a configuration workstation 130, a player server 140, a bonus server 150 and a promotion server 160. Hub 106 facilitates data flow to or from the configuration workstation 130 and the servers 140, 150, and 160. Additionally, the servers 140, 150, and 160 communicate through the concentrator 110 to the bank controllers 90, which, in turn, communicate with the particular gaming devices 10.

The configuration workstation 130 has a user interface that allows portions of the network 5 and the servers 140, 150, and 160 to be set up and modified. The configuration workstation 130 could include a personal computer having a keyboard, monitor, microprocessor, memory, an operating system, and a network card coupled to the Ethernet hub 102.

The player server 140 includes a microcomputer that is used to track data of players using the gaming devices 10. The player server 140 is coupled to a player database 142 where the player tracking data is stored. Another function of the player server 140 is to control messages that appear on displays 46 or 52 associated with each gaming device 10 and the messages on the signs 94 coupled to the bank server 90. The player server 140 may be embodied in a microcomputer including, for instance an Intel Pentium Processor, Microsoft operating system and a network card to couple the server to the Ethernet hub 106.

The bonus server 150 is embodied by a microcomputer and is used to control bonus applications or bonus systems on the gaming network 5. The bonus server 150 is coupled to a database 152 where bonus data is stored. The bonus server 150 implements includes a set of rules for awarding jackpots in excess of those established by the winning pay tables of each gaming device 10. Some bonus awards may be made randomly, while others may be made to link to groups of gaming devices 10 operating in a progressive jackpot mode. Specific examples of such bonuses and networks used to implement them include those as described in US patents mentioned above and previously incorporated.

The promotion server 160 is coupled to a promotion database 162 and a modeling parameters database 164. The promotion server 160 includes functions and processes operative to generate signals to cause a system award to be generated, and to communicate the generated system award to the particular gaming device 10 at which the player receiving the award can receive the award.

Data of different types of system and/or bonus awards and how and when the awards are generated can be stored in the promotion database 162. For instance, the text and/or graphics that is printed on an award, or bar-codes that are printed on the award ticket can be stored on the promotion database 162. Modeling parameters and data can be stored on the modeling parameters database 164. For instance, triggering conditions that when satisfied cause a ticket to be generated can be stored on this database. Such data could include the number of hours a player must play at a requisite coin-in level to cause a complementary meal ticket to be awarded to the player. Many examples of system awards and parameters used to implement them are discussed in detail below.

In determining when to grant a bonus or system award, the promotion server 160 can access data stored anywhere on the network looking for triggering events, such as: from any of the databases 142, 152, 162 and 164; from the configuration workstation 130; from the bank controller 90; from the accounting system 120; and from the bonus engine 50 on any or all of the gaming devices 10 coupled to the computer network 5. Additionally, the computer network 5 illustrated in FIG. 4 is only an example gaming network. Those skilled in the art will appreciate that embodiments of the invention can operate on any acceptable network, even if it differs from the one illustrated in FIG. 4.

When the promotion server 160 determines that a triggering event has been satisfied and that an award should be generated, it sends appropriate signals to the bonus engine 50 of the appropriate gaming device 10 through the gaming network 5 to deliver the award. As discussed above, one such method of award delivery is to cause an award ticket to be printed for the player.

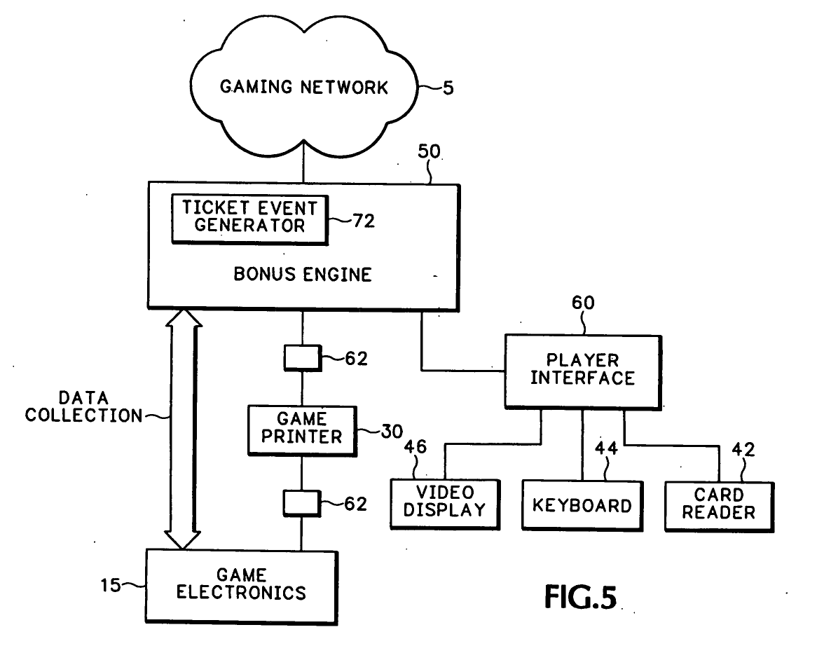

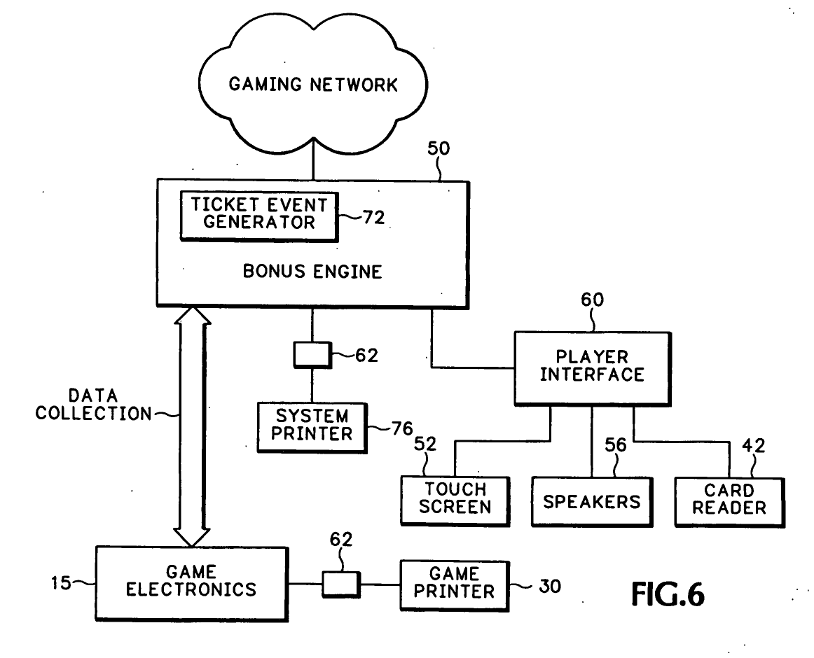

Details of how the bonus engine 50 causes the award tickets to be printed are shown in FIGS. 5 and 6. These figures are sample block diagrams showing example control functions and data connections between components of the gaming device 10 of FIG. 1. Functions operating on the illustrated components may be implemented in any way, such as by standalone hardware circuits, software processes running on a dedicated or shared processor, firmware, etc. or a combination of those implementations. Similarly, the functions could be procedures running on a general purpose or specialty microprocessor. Further, although components are shown as distinct interconnected components, the functions that are represented may operate in conjunction with one another in an overlapping manner.

As shown in FIG. 5, the bonus engine 50 is coupled directly to a data cable 12, which, in turn is coupled to the gaming network 5. The data cable 12 allows the bonus engine 50 to communicate game and player events to the game network 5. Additionally, the game network 5 sends commands and data to be performed or managed by the bonus engine 50.

The bonus engine 50 is coupled to the game electronics 15 through a data collection link, shown as a double arrow. The bonus engine 50 and the game electronics 15 may communicate using a data collection protocol, such as a Slot Accounting System protocol, or by any other acceptable protocol.

The bonus engine 50 is additionally coupled to the set of player communication tools—the card reader 42, keyboard 44 and text display 46. In some embodiments, the bonus engine 50 may be coupled to these player communication tools through a separate player interface 60, which routes commands and data from the bonus engine 50 to the appropriate tool. In other embodiments, the bonus engine 50 controls these operations itself, and no separate player interface 60 is necessary.

Within the bonus engine 50 is a ticket event generator 72. The ticket event generator is operative to cause the system award ticket or bonus award ticket to be printed. As discussed above, the granting of an award may occur on the promotion server 160, the bonus server 150, or may occur on the bonus engine 50, or some portions of the grant may occur on either the promotion or bonus server and on the bonus engine. For instance the bonus engine 50 may monitor events from the game electronics 15 and grant a special award when an award-causing (triggering) event occurs—without first sending data to the promotion server 160. Of course, once the award was generated, the bonus engine 50 would send the appropriate data to the gaming network 5, and specifically to the player server 140, bonus server 150, promotion server 160, and the accounting system 120.

The bonus engine 50 may be coupled directly to the game printer 30, or may be connected to a game printer interface 62 that in turn is coupled to the game printer 30. In either such an embodiment, the bonus engine 50 can generate requests to print award tickets and have them printed directly on the game printer 30, without sending intermediate commands to the game electronics 15. The bonus engine 50 or printer interface 62 may communicate directly to a port on the printer using a serial or parallel printing protocol, for instance. Alternatively, the print requests may be generated by the promotion server 160 or elsewhere on the gaming network 5, and communicated to the bonus engine 50 over the data cable 12. The bonus engine 50 in turn can then send appropriate commands to the printer interface 62 to control the game printer 30 to print the desired ticket.

In another embodiment, also shown in FIG. 5, the bonus engine 50 sends the print commands to the set of game electronics 15 over the data connection link, rather than controlling the game printer 30 directly. Once the game electronics 15 receives the print command from the bonus engine 50, it performs any necessary translation and sends the appropriate signals to the game printer 30 to print the award ticket. As above, the game electronics may be connected to the game printer through a game printer interface 62, which may or may not be identical to the game printer interface coupled to the bonus engine 50.

Therefore, in operation as illustrated in FIG. 5, the bonus engine 50 either generates or receives a command from the gaming network 5 to print an award. Once the command is generated or received, the bonus engine 50 either prints the award ticket directly on the game printer 30, or sends appropriate commands to the set of game electronics 15 to have the award ticket printed.

FIG. 6 illustrates an embodiment of the invention that includes two printers attached to the gaming device 10—a standard game printer 30 and a system printer 54. As discussed above with reference to FIG. 3, the system printer 54 can be identical to or different from the standard game printer 30.

As shown in FIG. 6, the bonus engine 50 is coupled directly to a system printer interface 64, which in turn is coupled to the system printer 54. In some embodiments, the functions of the printer interface 64 are built directly into the bonus engine 50 so that a separate printer interface is unnecessary. As in the other embodiments, the game electronics 15 are still connected to the standard game printer 30, and are used to print standard game items, such as cashout vouchers. In this embodiment, the system printer 54 is controlled by the bonus engine 50 solely to print system and bonus awards.

Also different from the gaming device shown in FIG. 5 is that the gaming device 10 of FIG. 6 is coupled to the touchscreen 52 and speakers 56 that were described with reference to FIG. 3. As described above, embodiments of the invention are capable of operating equally no matter the type of system used to communicate with the player of the gaming device 10.

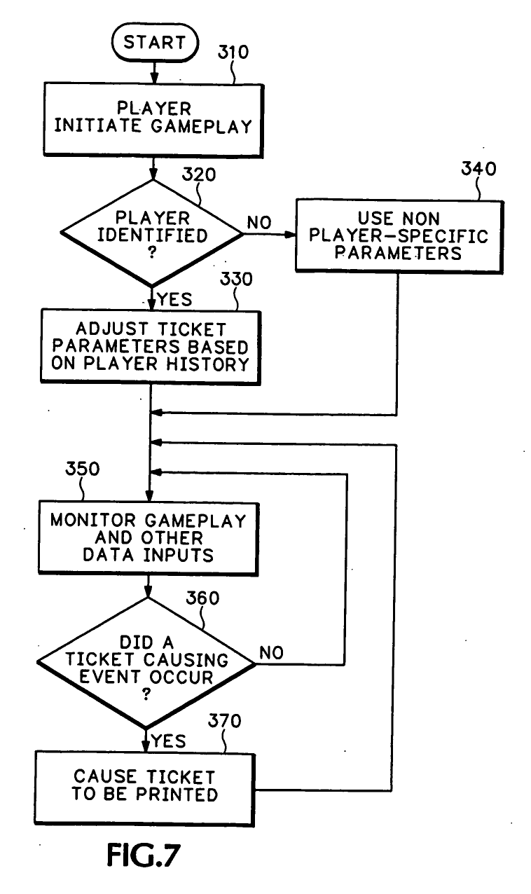

FIG. 7 is an example flow diagram illustrating processes that can be used by the promotion server 160 or ticket event generator 72 to cause an award to be generated and an award ticket printed at a gaming device 10. For brevity, functions relating to generating an award will be referred to as occurring on the promotion server 160, although they could be performed on either the promotion server, bonus server 150, bonus engine 50, or elsewhere in the computer network 5. Similarly, printing awards will be referred to as being printed on a system printer 76, although they could also be printed on a game printer 30, either under direct control of the bonus engine 50, or under control of the game electronics 15 after receiving commands and data from the bonus engine.

A flow 300 begins at a process 310 where a player initiates gameplay on a gaming device 10 that is coupled to the gaming network 5. A player may initiate gameplay by entering coins or bills into the gaming device 10, or by using a card and/or PIN number to transfer money from a casino account, for example.

A check is made at 320 to see if the player has been identified to the gaming network 5, either as a new player or as a returning player. If the player is so identified, a process 330 loads data from the player database 142, and/or adjusts parameters in the promotion server 160. Otherwise, a process 340 loads non-player specific parameters to the promotion server 160. In some embodiments, the process 340 is presumed, and the non-player specific parameters are pre-loaded into the promotion server 160 when the function begins, and are only overwritten if there is in fact data about the current player stored in the player database 142. Information from the promotional server 160 may be also used by the bonus server 150.

A process 350 monitors gameplay as well as other data inputs. Some of the other data inputs can include time of day, and the presence of special promotions, for example. In implementation, the other data inputs can include a large variety of inputs, which are described in detail below.

If a check 360 does not find a ticket causing event to have occurred, then the flow 300 simply loops back to the process 350, and the monitoring continues. If, instead the check 360 finds that a ticket causing event occurred, then the promotion server 160 or bonus server 150 loads the appropriate data and sends a signal to the bonus engine 50 of the appropriate gaming device 10 to cause the printer 76 to print an award ticket. For instance, if a player has played for over 3 hours at a requisite level, the promotion server 160 may cause a ticket for a free meal (a complementary or “comp” meal) to be printed at the game device 10 where the player is currently playing.

In other embodiments, the ticket printer can also be used as a vehicle to issue a receipt. For instance, a ticket could be printed at a gaming machine that confirms a transfer of funds or credits to a player. For example, if a player electronically transferred funds into a player account, the ticket printer could be used to print a receipt that confirms how much the player transferred, and/or how much is remaining in the player's account.

Triggering Events:

Generally, using the award system described above, an award is generated after an award triggering event occurs. As described above, a trigger event occurs when conditions caused by the customer, the game itself or gaming network satisfy one or more pre-set conditions. The pre-set conditions are “triggers”, and when a trigger's conditions are satisfied, the trigger event occurs.

The triggers are typically static, such as awarding a complementary meal coupon when a player has a requisite amount of coin-in over a meal period. Other triggers can be dynamic or based on dynamic variables, such as awarding a free return play to the top 10% of players in a casino or group of casinos over a given time period.

A list of example groups of triggering events is listed below in Table 3.

TABLE 3
List of Trigger groups, by type:

| | | Random |
|---|---|---|
| Machine Outcome | Player Behavior | Triggers |
| Specific Game Outcomes | Points Earned | Lucky Coin |
| Series of Game Outcomes | Win/Loss Per | Lucky Time |
| | Unit of Time | |
| Sets of Game Outcomes | Visitation | Lucky Game |
| | Frequency | |
| Consecutive Game | Handle Per | Electronic |
| Outcomes | Unit of Time | Drawing |
| X outcomes in N tries | Continuous Play | |
| Outcome sets/unit time | Specific Player | |
| | Demographics | |
| Outcomes relative to others | Sets of Player | |
| | Demographics | |

Trigger Definitions:

A “Specific Game Outcomes” triggering event occurs when the player obtains a predefined result on a game on the gaming device. Examples include, for instance, a “four-of-a-kind” (or a particular four, such as four aces) in a poker game, “seven-seven-seven” in a slot game, or obtaining a particular bonus symbol on one of the reels. An award can be generated when any particular predefined outcome of the game is met.

A “Series of Game Outcomes” triggering event occurs when the player obtains certain results during multiple plays on the gaming machine device in a predetermined order. One example is where a player obtains, on a video poker machine, a pair, two pairs, three-of-a kind, straight, and flush in that order but not necessarily consecutively. An award can be generated when any predefined series of results is met.

A “Sets of Game Outcomes” triggering event occurs when the player obtains certain results during multiple plays on the gaming machine regardless of order. Examples include a player receiving his/her fourth four-of-a-kind on a video poker machine, or a player obtaining jackpot payouts on each of the possible paylines in a slot-based game. An award can be generated when the last in the predefined set of results is met.

A “Consecutive Game Outcomes” triggering event occurs when the player obtains certain consecutive results during multiple plays on the gaming machine. Examples include a player winning on five consecutive hands or receiving two consecutive hands containing a minimum level of win (such as three-of-a-kind) on a video poker machine, or where a player receives a particular bonus symbol on the payline of a slot machine three consecutive times. An award can be generated when the last of the predefined consecutive game outcomes is met.

An “X Outcomes in N Tries” triggering event occurs when the player obtains certain results during multiple plays on the gaming machine within a certain number of tries. Examples include a player obtaining a both a straight and a flush within five games of one another, but not necessarily consecutively or in that order, or where a player obtains seven-seven-seven during the first 50 plays of a particular slot machine. An award can be generated when the “xth” outcome is reached by the player.

An “Outcome Sets/Unit Time” triggering event occurs when a player obtains certain results during multiple plays on the gaming machine primary game within a set period of time. Examples include a player obtaining 10 jackpot awards on a slot machine within a ten minute period, and a player obtaining three flushes within a one-hour period on a video poker machine. This type of trigger allows the operator to specify the game outcomes and the time limit required for the trigger.

An “Outcomes Relative to Others” triggering event occurs when a player obtains a certain result or results on the gaming device before (or after) other players at a specified group of games. Examples include the first player in a bank of video poker machines to receive a four-of-a-kind of Aces, or the first one to twenty wins.

A “Points Earned” triggering event occurs when a player earns a certain number of points on the gaming device, such as: bonus points, Xtra credit points, or even machine credits. An award can be generated when such a minimum point level is met.

A “Win/Loss Per Unit of Time” triggering event occurs when a player obtains a certain number of wins or loses on a gaming device over a predetermined time period. Examples include a player losing 100 times over a 20 minute time period, or where a player wins 7 times over a one-minute period.

A “Visitation Frequency” triggering event occurs to reward players for frequent visits to the casino(s). Examples include triggering the award upon the third consecutive day the player visits a particular casino, the fifth visit to any casino within a group of casinos within a year, or after a player has played for a total of twenty-four hours of non-continuous play. Flags maintained within the player database 142 within the gaming network 5 allow a casino to track this type of visitation and play criteria over a long period of time.

A “Handle Per Unit of Time” triggering event occurs for players betting a certain amount over a certain time period. Examples include a player betting at least a total of $500 at a slot machine over a one-hour period, or where a player bets his/her 1000^{th} coin at a nickel poker machine.

A “Continuous Play” triggering event occurs after the player has continuously played on a machine for a preset time period. For instance, the award might be triggered every ten minutes of play, or a super promotion after two hours of continuous play.

A “Specific Player Demographics” triggering event occurs only for those players fitting the specific profile designated. For instance, the casino might run a promotion where players from Chicago or from out of state receive the promotion the first time during any one day that they play particular machines. The demographic information is stored in the player database 142 on the gaming network 5, and the player ID is established when the player inserts his/her player tracking card and/or typing in a PIN. Additionally, player demographics stored in the promotion server 160 or elsewhere on the gaming network 5 can include player grouping or ranking used to signify the betting patterns of different players. For instance, “high rollers” would have higher rankings than lower betting players.

A “Sets of player Demographics” triggering event occurs for those players fitting more than one (and perhaps all of the) designated profiles that are stored in the promotion server 160 or elsewhere on the gaming network 5. For instance, the casino might run a promotion for seniors aged 65 and older who come from out of state. Again, the individual demographic information is stored in the player database 142 coupled to the player server 140 on the gaming network 5.

A “Lucky Coin” triggering event occurs for a player inserting the xth coin-in on a certain pre-designated portion of the games coupled to the gaming network 5. An award can be generated when the coin is inserted or credit otherwise transferred.

A “Lucky Time” triggering event occurs for a random player playing at a designated time of day.

A “Lucky Game” triggering event occurs for a random player who is playing on one of the gaming devices coupled to the gaming network 5.

An “Electronic Drawing” triggering event occurs where a player is awarded a drawing ticket. Detailed discussion of this trigger event appears below.

These are only a small sample of potential triggering events that can be contemplated and the invention should not be so limited to those disclosed and described. Embodiments of the invention could conceivably use any data accessible anywhere in the gaming network 5 to create a trigger. The triggers could be as simple as to award system awards to everyone who is playing at 3:00 pm Friday to as complex as imaginable. A trigger may have a single component, such as that described above, or could have dozens of components (e.g.: a free spin to players who have a current coin-in level that is 15% higher than their coin-in average for the last month if the player is playing at a game introduced in the last 4 months and is staying in the casino hotel). The number of different triggers possible in the gaming network 5 is nearly infinite. Implementation overhead, however, may limit the casino to minimizing the number of components of a trigger, or the amount of calculation that has to be performed to check whether certain trigger conditions have been met.

Triggering events need not be applied uniformly to all of the gaming devices coupled to the gaming network 5, or to all of the players playing the gaming devices. There may be different triggering events or sets of triggering events for different groups of gaming devices. For example, with reference to FIG. 4, a first set of triggering events could apply to the EGMs 10 that are in bank 82, but not to those EGMs in banks 84 and 86. That is, there could be a triggering event implemented, such as generating a drawing ticket after “x” minutes of play, where “x” is 40 minutes for EGMs in bank 82, 50 minutes for EGMs in bank 84 and 60 minutes for EGMs in bank 86. Of course, although illustrated here as groups of EGMs associated with a particular bank, any of the EGMs 10 within the entire network 5 could have one or more triggering events that are different from any other EGM.

The same level of control extends to player groupings as well. For instance, certain triggering events could be set up for those players who have signed up for player tracking in the past 6 months, while another set of triggers applies to other players. Individual tailoring of a gaming network based on player identity is disclosed in copending application entitled “Player Specific Game System”, filed Sep. 18, 2002 and having Ser. No. 10/247,786, which is assigned to the assignee of the present invention and incorporated herein by reference for all purposes. One way to tailor the gaming network is to have different triggers for groups of players, or for individual players themselves.

Using the Ticket Printer System in Game Promotion

Once a ticket printing system such as the one described above is established, several types of promotions to promote game play can operate on such a system. The promotions can include generating system award tickets for the player, as described below.

One such promotion is a drawing ticket promotion. In this promotion, a player identifies himself or herself to the player server 140 on the gaming network 5. Once identified, bonus points are accumulated based on amount of play, such as “coin-through”, as is known in the art, and tracked in the player account stored on the player database 142. Once the bonus points have accumulated to 100, or some other set number, the promotion server 160 causes a “drawing ticket” to be printed for the player. The drawing ticket is a system award. In some embodiments, the promotion server 160 will generate a “drawing” ticket for each 100 bonus points that the player accumulates. Each drawing ticket has a unique number printed on the ticket, and data of the drawing ticket is stored in the player database 142. At a pre-determined time, a drawing is held for a prize, such as money, credits, or another type of prize. One of the numbers that was printed on the drawing tickets that were generated during a given time period is selected as the winning ticket. The drawing rules may require that the player be present to win. Doing so could encourage players to return at a specific time, which could in turn promote additional play on the gaming machines. Or, because the numbers on the drawing tickets can be automatically associated with a player and stored in the player's account, the player would not necessarily need to be present to win.

In operation, this promotion could use data from each of the databases illustrated in FIG. 4. For instance, player data such as past playing history from the player database 142 can be considered. Bonus data from the bonus database 152 may also be used. Data regarding when and where to generate the system award, and formatting data used to print the ticket can be retrieved from the databases 162, 164. Additionally, modeling parameter data, such as the requisite number of bonus points accumulated prior to generating the drawing ticket, can be retrieved from the parameter database 164. The promotion server 160 can utilize data from each of those inputs and others on the gaming network 5 to determine when to generate the ticket.

Also, referring to FIG. 7, the ticket printing promotion can implement the looping processes 350 and 360 while it is continuously monitoring the important parameters. Once all of the parameters are present to cause a ticket to be generated, the flow 300 passes to the process 370, where the ticket is generated. Once the ticket is generated, the flow 300 returns to the process 350 to again monitor the data inputs.

Another type of promotion could be used to encourage an unidentified player to become an identified player. Sometimes, for privacy or other reasons, players do not want to be identified. Or, perhaps a player didn't have a player identification card with them when they went to play at a particular casino.

The promotion involves identifying a player who is accumulating bonus points but, because the player is unidentified, the bonus points are not credited to a certain player account. The unidentified player is invited to identify himself or herself and have the bonus points added to either a new or their existing player account. Possibly the player may be convinced to identify himself or herself, which can benefit the casino, if the potential player award is high enough. In this promotion, the promotion server 160 monitors the gameplay of a non-identified player. If the player exceeds a threshold that indicates they are doing well, for example if they accumulate over 25 bonus points, the promotion server 160 causes a prize ticket for a system award to be awarded. The player can take their prize ticket to a customer service desk in the casino to claim their prize. However, the player must sign up for a player account to be eligible to receive the prize. If the player was in fact a player who already had an account but did not identify themselves to the gaming network, then the bonus points that the player accumulated could be credited to the proper account at the customer service desk.

In this instance the ticket could print with a particular numerical code that identified how many bonus points that were accumulated. Then, the casino employee can access the gaming network to properly credit the accumulated bonus points, based on the numerical code assigned.

Another promotion encourages the player to stay in a hotel associated with the particular casino in which the player is playing. One of the items that can be stored in the player database 142 is whether the player is staying in the hotel associated with the casino where the gaming network 5 is installed. A promotion to encourage the player to stay in the casino hotel operates by using this information in conjunction with other parameters stored in the modeling parameters database 164 or player database 142. For instance, the promotion server 160 can monitor the gameplay of the player who is not staying in the hotel. Once the player has played for a certain period of time, for example over 3 hours, the promotion server 160 can grant a system award offering a complementary or discounted room in the casino. If the player is staying at the particular casino's hotel, they may be more likely to play the games for a longer period of time.

Another promotion utilizes the ticket printer 76 in conjunction with the keyboard 42 and display 46 or touchscreen 52 mounted on the gaming device 10. In such a promotion system, the promotion server 160 determines that some sort of system award should be given to the player, but allows the player to choose which system award they would like. In implementation, when an event causes the promotion server 160 to send a system award to the player, instead of instructing the bonus engine 50 to cause a ticket to be printed, a selection mechanism is provided to the player. For instance, the bonus engine 50 may cause a display to be shown on the touchscreen 52 that includes several different prizes. For example, a player could be given the choice of a complimentary meal or bonus credits. Or the player could be given the choice of a meal, bonus credits, and one or more drawing tickets (described above). The player could then make his or her selection from the items displayed, and the bonus engine 50 would cause the appropriate system award ticket or receipt to print at the printer 76. For instance, if the complementary meal were selected, a meal voucher would be printed for the player that can be redeemed in the casino restaurant.

Another promotion using the ticket printer 76 can encourage a player to return. For instance, when the player cashes out or decides to leave, a ticket inviting the player back is printed at the printer 76. The ticket could indicate that if the customer returns within a certain time, for instance 24 hours, the player will qualify for a system award of free play or bonus credits. Of course, the time period in which to return and the amount of system award given upon return can be adjusted by the casino operator.

Another promotion utilizes both the display screen 46 or 52 and the ticket printer 76, but need not actually be related to the gaming device 10. For instance, a player may identify himself or herself to the gaming network 5 by inserting a casino card and/or entering a PIN number. Then, the bonus engine 50 or other portion of the gaming network 5 generates a menu where the player can view the status of the player's account. For instance, the player could check to see how many bonus points they have accumulated. Then, by making appropriate selections on the display screen 46 or 52, the player can manage their bonus account. For example, the player could choose to convert some of their bonus points into a complementary meal. In such a case, bonus points are deducted from the player's account, and a complimentary meal ticket for the system award is printed at the ticket printer 76.

A further method of using the ticket printer 76 is to print instructions or a receipt for use by the player. For example, if the player is potentially confused about the rules of a particular game, or would like clarification on the way a bonus works, a selection can be presented on the display 46, 52. When the player makes a selection, the bonus engine 50 causes the ticket printer 76 to print out the rules or instructions on a ticket or series of tickets for the player to have and take with him or her.

By generating tickets for awards at appropriate times, a casino can promote loyalty from its patrons. For instance, by specially rewarding customers who play many hours at the games, customers are likely to play longer than if they weren't rewarded.

Although examples of machines and processes have been described herein, nothing prevents embodiments of this invention from working with other types of machines and processes. Implementation of the promotion system is straightforward in light of the above description. As always, implementation details are left to the system designer. The specific circuits and procedures used to decide when tickets should be produced, and the way the actual tickets are produced may be implemented in any way, with any components, so long as they can generate the desired effect. Inclusion of description or illustration of a function in either the gaming device or the gaming network is not dispositive that the function is located in or must be performed there. The award generating system works even when not all of the illustrated functions are present

Examples of Printed Tickets

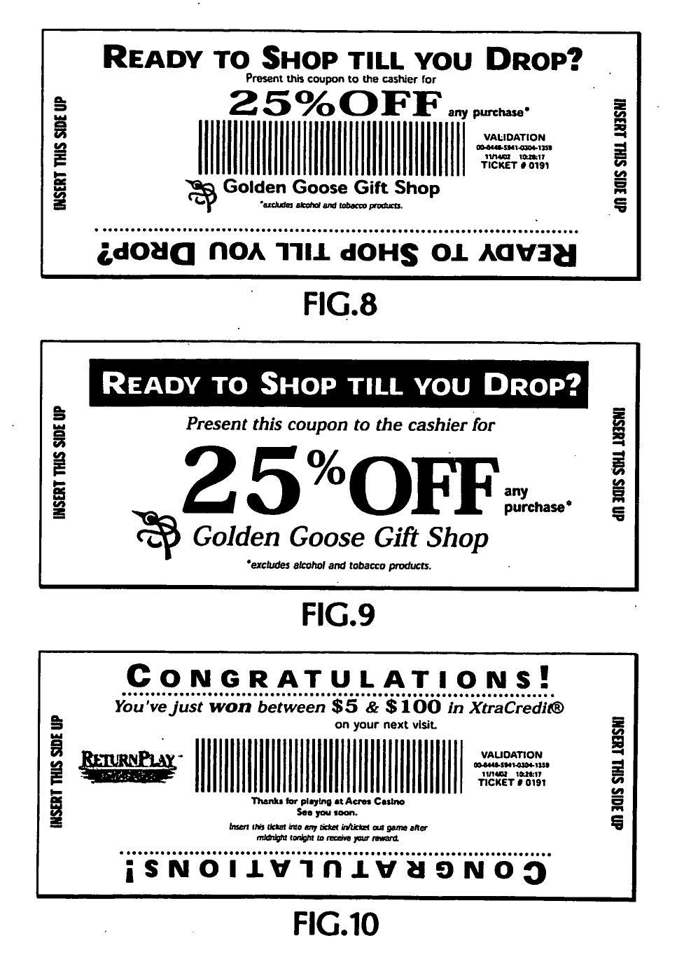

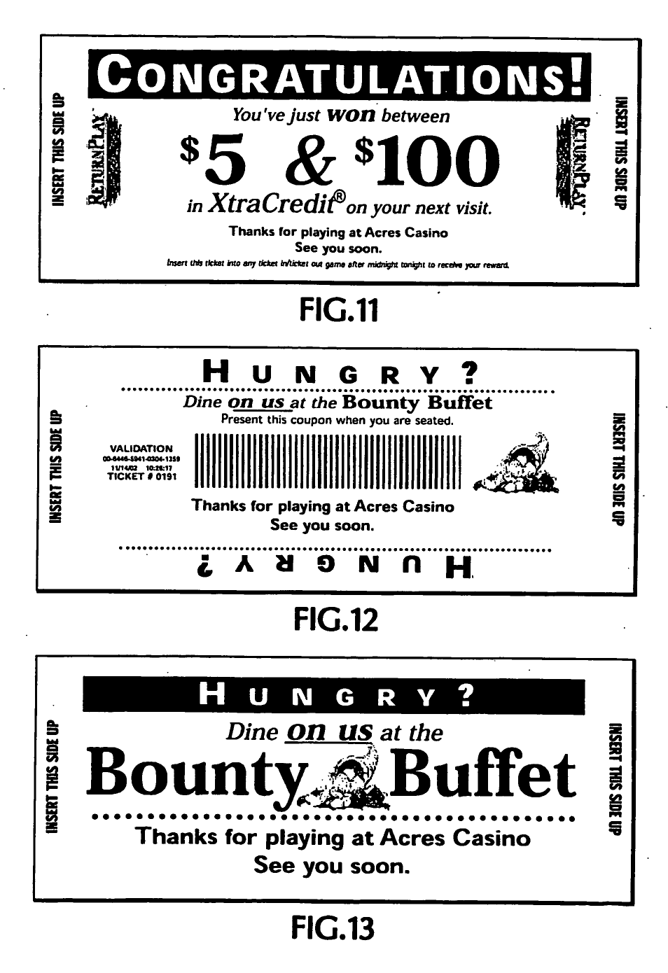

FIGS. 8-13 show examples of tickets representing awards that can be printed at the gaming device 10 using embodiments of the invention. As described above, when the award is granted by the gaming network, codes are generated by the ticket event generator 72 on the bonus engine 50 (or elsewhere on the gaming network 5) to cause the game printer 30 (FIG. 5) or the system printer 76 (FIG. 6) to generate the tickets. A record of the generated ticket is stored in the player database 142 and/or elsewhere on the gaming network 5. For instance, the record of the generated ticket may also be stored in the bonus database 152, promotion database 162, and/or on the modeling parameters database 164 (FIG. 4).

Some of the tickets, for instance those illustrated in FIGS. 8, 10, and 12, include a barcode printed directly on the ticket. The barcode may identify the particular singular ticket, or the type of ticket generated. If applicable, the player may redeem the printed ticket by inserting the ticket into the bill acceptor 20 of the gaming device 10 (FIG. 1). The bill acceptor can check the data record stored on the player database 142 for the particular identified player to determine if the player is eligible to receive such an award. If eligible, the player's record is updated to reflect that the award has been redeemed. This prevents unauthorized use of awards, such as by transferring awards to players not eligible to receive them or copying another's award.

Having described and illustrated the principles of the invention in a preferred embodiment thereof, it should be apparent that the invention can be modified in arrangement and detail without departing from such principles. We claim all modifications and variation coming within the spirit and scope of the following claims.

1. A method for awarding a bonus to a user of a wagering or point of sale device at one of a plurality of sites, said method comprising:
collecting data relating to player activity at a wagering or point of sale device at each of the sites;
compiling at least some of the data collected from each of the sites;
selecting at least one of the devices at one of the properties;
awarding a bonus to the player of the device; and
generating an indication that the player has been awarded a bonus.

2. The method of claim 1 wherein collecting data relating to wagering or point of sale device at each of the sites is performed by a slave server on a computer network at each property.

3. The method of claim 2 wherein compiling at least some of the data is performed by a master server on a network including the slave servers.

4. The method of claim 1 wherein said at least one wagering or point of sale device is selected, at least in part, independently of a pay table for said at least one wagering or point of sale device.

5. The method of claim 1 wherein said method further includes identifying at least some of the players of the wagering or point of sale device and selecting said at least one player only from identified players.

6. The method of claim 1 wherein said method further includes tracking wagers or purchases made at each wagering or point of sale device having an identified player and wherein compiling at least some of the data includes compiling wagering or purchasing at each wagering or point of sale device having an identified player.

7. A system for awarding a bonus to at least one user of a wagering or point of sale device at one of a plurality of sites, said method comprising:
a slave server at each site, said slave server being on a network of wagering or point of sale devices at its associated property and being programmed to accumulate a wagering or purchasing count related to use on the networked wagering or point of sale devices;
a master server on a network of the slave servers, said master server being programmed to accumulate the wagering or purchasing counts of each slave server for each identified player; and
a process distributed between the master and slave servers for awarding a bonus to at least one identified player of one of the gaming devices at one of the sites when the accumulated count on the master server reaches or exceeds the random number.

8. A system for tracking play at a pari-mutuel facility, the system comprising:
a patron management database for storing player information including player activity, points, and point redemptions;
an interface module coupled to the patron management database via a TCP/IP link;
a plurality of distributed sites and for each site:
a local player cache capable of storing player information uploaded to the local player cache from the patron management database, and
electronic gaming terminals coupled to the local player cache at which the player makes wagers; and
a bonus engine adapted to transmit payment instructions to the player responsive accumulated play at the electronic gaming terminals.

9. The system of claim 8, wherein the electronic gaming terminals are betting kiosks for placing wagers on pari-mutuel activities.

10. The system of claim 9, wherein the pari-mutuel activities is track betting.

11. A method for awarding bonuses for play of a pari-mutuel wagering event comprising the steps of:
storing in a central patron management server data related to past player wagering activity;
transferring said wagering data to a local player cache responsive to identification of a player wagering at an identified wagering site;
tracking in the local player cache data related to current player wager activity; and
awarding a bonus to the identified player responsive to play criteria on the pari-mutuel wagering event exclusive of outcome.

12. The method of claim 11, wherein the play criteria is play of a predetermined number or amount of wagers within a specified time frame.

13. The method of claim 12, the bonus including a free race wager for pari-mutuel wagering.

14. The method of claim 12, the bonus including a free multi-use wager for pari-mutuel wagering.

15. The method of claim 12, the bonus including a free race wager for pari-mutuel wagering redeemable by the player only until a specific point in the future.

16. The method of claim 12, the bonus including an electronic drawing for pari-mutuel wagering wherein the player receives one of a plurality of tickets and at a predetermined time a winning ticket is selected.

17. The method of claim 12, the bonus including an award redeemable at any one of a plurality of sites.

18. The method of claim 12, the bonus including a randomly awarded amount funded by a percentage of the wagers made.

19. The method of claim 11, the method further including the step of determining player eligibility to receive the bonus.

20. The method of claim 19, the step of determining player eligibility including making only tracked players eligible for the bonus.

21. The method of claim 20, the step of determining player eligibility including specifying in advance of play a particular time frame in which the player is eligible.

22. The method of claim 20, the step of determining player eligibility including making eligible only those players who make a wager within a predetermined time period.

23. The method of claim 20, the step of determining player eligibility including making eligible only those players that make a predetermined number of visits within a specific time frame.

24. The method of claim 20, the step of determining player eligibility including making eligible those players that play a predetermined exotic wager.

25. The method of claim 24, wherein those exotic wagers are taken from the group consisting of Daily Double, Exacta, Quinella, Trifecta, Pick Three.

26. The method of claim 20, the step of determining player eligibility including making eligible those players who selects a predetermined number of winning wagers.

27. The method of claim 20, wherein eligibility is determined by those players who wager a minimum of monetary amount, on a specific type of wagering, within a specific time frame.

28. A method for awarding a bonus responsive to wagering activity comprising:
collecting within a central database data relating to player wagering activity characterized by a selection by the player of a predicted outcome of a future event;
storing within a database the selected outcome;
awarding a payout to the player if the outcome is satisfied by a determination of the future event; and
awarding a bonus to the player in association with the player wagering activity.

29. The method of claim 28, wherein the bonus is awarded in advance of the determination of the future event.

30. The method of claim 29, wherein the bonus is awarded contemporaneously with the selection by the player of the particular outcome of the future event.

31. The method of claim 30, wherein the bonus is awarded via a ticket printed out at a betting terminal.

32. The method of claim 28, wherein the bonus is determined by the predicted outcome.
